(19) United States
(12) Patent Application Publication
(10) Pub. No.: US 2015/0106586 A1
(43) Pub. Date: Apr. 16, 2015

(54) METHOD AND A DEVICE FOR CONTROLLING MEMORY-USAGE OF A FUNCTIONAL COMPONENT

(71) Applicants: Ville HALLIVUORI, Espoo (FI); Kari KAMUNEN, Vantaa (FI); Juhamatti KUUSISAARI, Helsinki (FI)

(72) Inventors: Ville HALLIVUORI, Espoo (FI); Kari KAMUNEN, Vantaa (FI); Juhamatti KUUSISAARI, Helsinki (FI)

(73) Assignee: TELLABS OY, Espoo (FI)

(21) Appl. No.: 14/514,789

(22) Filed: Oct. 15, 2014

(30) Foreign Application Priority Data
Oct. 16, 2013 (FI) 20136023

(51) Int. Cl. G06F 12/10; H04L 12/741; H04L 29/08

(52) U.S. Cl. CPC G06F 12/1027; H04L 67/1097; H04L 45/745; G06F 2212/657
USPC 711/207

(57) ABSTRACT

The invention relates to controlling memory-usage of a functional component, e.g. a network interface of a router or a switch. A portion of a virtual memory organized to comprise virtual memory pages is reserved (201) for the use of the functional component. Mapping between the virtual memory pages and physical memory areas implemented with a physical memory is formed (202), and data items providing accesses to the physical memory areas are written (203) to one or more of the physical memory areas. The functional component is enabled to directly access to a physical memory area mapped to a virtual memory page so that the data item that provides access to this physical memory area is read (204) from the physical memory with the aid of the mapping and a virtual memory address related to the virtual memory page, and the read data item is delivered (205) to the functional component.

### FIELD OF THE INVENTION

The invention relates to a method and to a device for controlling memory-usage of a functional component that can be, for example but not necessarily, a network interface of a network element, e.g. a network interface of an Internet Protocol “IP” router. Furthermore, the invention relates to a computer program for controlling memory-usage of a functional component and to a network element.

### BACKGROUND

A virtual memory is a concept relating to a memory management technique that maps memory addresses used by a process, called virtual addresses, into physical addresses of a physical memory. The virtual memory seen by a process can appear as a collection of fixed-length contiguous virtual memory blocks called virtual memory pages which are basic data units for managing the mapping between the virtual memory and the physical memory. The size of each virtual memory page is advantageously a power of 2 such as, for example but not necessarily, 2¹² bytes=4096 bytes. The operating system manages the mapping between the physical memory and the virtual memory. Address translation functionality, often referred to as a memory management unit “MMU” or a paged memory management unit “PMMU”, automatically translates virtual addresses to physical addresses so that the process under consideration can operate with the virtual addresses.

In conjunction with many electronic devices, such as e.g. network elements of a data transfer network, it is not only a central processing unit “CPU” which runs one or more processes using a physical memory but there are also peripheral components such as network interfaces, e.g. line cards “LC”, and network processors “NP” which also use the physical memory. Therefore, there is a need to manage the memory-usages of the one or more processes run by the CPU and of the peripheral components so that they do not disturb each other. A traditional way to arrange the memory-usages of the one or more processes run by the CPU and of the peripheral components is to handle the processes run by the CPU and the peripheral components in the same way so that, for each of these, a specific virtual memory is provided by an operating system that manages the mapping between the physical memory and the virtual memories and the memory management unit “MMU” is used for translating the virtual addresses to the physical addresses. The memory-usage of peripheral components such as e.g. network processors, which handle data packets or frames, can be rapidly changing over time. Therefore, an inconvenience related to the above-described traditional way for managing the memory-usages is that the operating system has to frequently carry out the memory management for the peripheral components and, as a corollary, resources running the operation system may be so heavily loaded that these resources may in some cases constitute a bottle neck limiting the capacity of the whole electronic device.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new device for controlling memory-usage of at least one functional component that can be, for example but not necessarily, a network interface of a network element, e.g. a network interface of an Internet Protocol “IP” router. A device according to the invention comprises a processor system configured to:
reserve a portion of a virtual memory, the reserved portion of the virtual memory comprising one or more mutually non-overlapping and contiguous virtual memory pages,
form mapping between the virtual memory pages and physical memory areas implemented with a physical memory, a particular one of the physical memory areas being mapped to a particular one of the virtual memory pages, and
write, to one or more of the physical memory areas mapped to the virtual memory pages, data items providing accesses to the physical memory areas.

In order to enable the functional component to access to the one of the physical memory areas, the processor system is further configured to:
read, from the physical memory and on the basis of at least the mapping and a virtual memory address related to the one of the virtual memory pages, a particular one of the data items that provides access to the one of the physical memory areas, and
deliver information indicated by the read data item to the functional component so as to enable the functional component to access to the one of the physical memory areas.

The above-mentioned data item may include the physical memory address related to the physical memory area under consideration, or the data item may contain information with the aid of which the physical memory address is derivable or obtainable.

The above-described device is based on the principle that the data item providing access to the physical memory area under consideration is written to the physical memory so that the data item is readable with the aid of the virtual memory address related to the virtual memory page that is mapped to the physical memory area under consideration. Hence, when allocating the physical memory area under consideration, the data item providing the access to this physical memory area can be obtained with the aid of the said virtual memory address. Thus, the typical problem related to many hardware architectures that physical addresses resulting in translations done by a memory management unit “MMU” cannot be delivered to functional components, such as e.g. network interfaces, can be circumvented in a robust way.

In a device according to an advantageous and exemplifying embodiment of the present invention, the processor system is configured to prevent changes of the above-mentioned mapping between the virtual memory pages and the physical memory areas in situations where another mapping between another virtual memory and other physical memory areas is formed or changed. The changes can be prevented for example with the aid of one or more suitable flag variables.

In accordance with the invention, there is provided also a new network element than can be for example an Internet Protocol “IP” router, an Ethernet switch, a multiprotocol label switching “MPLS” switch, a network element of a software defined network “SDN”, and/or an Asynchronous Transfer Mode “ATM” switch. A network element according to the invention comprises:
one or more network interfaces for receiving and transmitting data to a data transfer network,
a physical memory for buffering the data received and to be transmitted, and
a processor system connected to the physical memory and to the one or more network interfaces,
   wherein the processor system is configured to constitute a device according to the present invention for controlling the usage of the physical memory by the one or more network interfaces.

In accordance with the invention, there is provided also a new method for controlling memory-usage of at least one functional component. A method according to the invention comprises:
reserving a portion of a virtual memory, the reserved portion of the virtual memory comprising one or more mutually non-overlapping and contiguous virtual memory pages,
forming mapping between the virtual memory pages and physical memory areas implemented with a physical memory, a particular one of the physical memory areas being mapped to a particular one of the virtual memory pages, and
writing, to one or more of the physical memory areas mapped to the virtual memory pages, data items providing accesses to the physical memory areas.

In order to enable the functional component to access to the one of the physical memory areas, the method further comprises:
reading, from the physical memory and on the basis of at least the mapping and a virtual memory address related to the one of the virtual memory pages, a particular one of the data items that provides access to the one of the physical memory areas, and
delivering information indicated by the read data item to the functional component so as to enable the functional component to access to the one of the physical memory areas.

In accordance with the invention, there is provided also a new computer program for controlling memory-usage of at least one functional component. A computer program according to the invention comprises computer executable instructions for controlling a programmable processor to:
reserve a portion of a virtual memory, the reserved portion of the virtual memory comprising one or more mutually non-overlapping and contiguous virtual memory pages,
form mapping between the virtual memory pages and physical memory areas implemented with a physical memory, a particular one of the physical memory areas being mapped to a particular one of the virtual memory pages, and
write, to one or more of the physical memory areas mapped to the virtual memory pages, data items providing accesses to the physical memory areas.

The computer program further comprises computer executable instructions for controlling the programmable processor to carry out the following actions in order to enable the functional component to access to the one of the physical memory areas:
reading, from the physical memory and on the basis of at least the mapping and a virtual memory address related to the one of the virtual memory pages, a particular one of the data items that provides access to the one of the physical memory areas, and
delivering information indicated by the read data item to the functional component so as to enable the functional component to access to the one of the physical memory areas.

In accordance with the invention, there is provided also a new computer program product. The computer program product comprises a non-volatile computer readable medium, e.g. a compact disc “CD”, encoded with a computer program according to the invention.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

The exemplifying embodiments of the invention and their advantages are explained in greater detail below with reference to the accompanying drawings, in which:

FIG. 1 illustrates an exemplifying data structure related to an exemplifying embodiment of the invention,

FIG. 2 shows a flow chart of a method according to an exemplifying embodiment of the invention for controlling memory-usage of at least one functional component,

FIG. 3 illustrates an exemplifying data structure related to an exemplifying embodiment of the invention, and

FIG. 4 shows a schematic illustration of a network element comprising a device according to an exemplifying embodiment of the invention.

### DESCRIPTION OF EXEMPLIFYING EMBODIMENTS

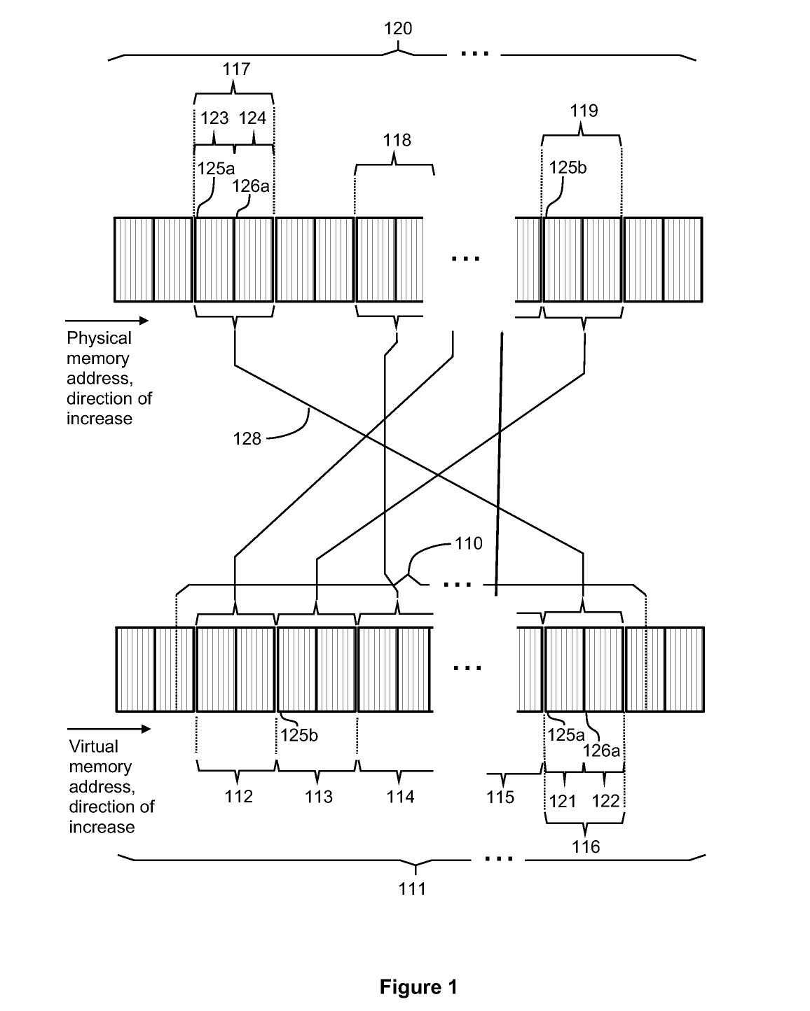

FIG. 1 illustrates an exemplifying data structure related to an exemplifying embodiment of the invention. A virtual memory 111 is organized to comprise fixed-length contiguous virtual memory blocks called virtual memory pages. In FIG. 1, some of the virtual memory pages are denoted with reference numbers 112, 113, 114, 115, and 116. The virtual memory 111 is implemented with a physical memory 120 which can be realized with one or more memory devices such as for example one or more random access memory “RAM” circuits. The virtual memory pages are basic data units for managing the mapping between the virtual memory 111 and the physical memory 120. In FIG. 1, the mapping between the virtual memory pages and fixed-length contiguous physical memory areas of the physical memory 120 are illustrated with connection lines one of which is denoted with a reference-number 128. In the exemplifying case illustrated in FIG. 1, the virtual memory page 113 is implemented with a physical memory area 119, the virtual memory page 114 is implemented with a physical memory area 118, and the virtual memory page 116 is implemented with a physical memory area 117. The size of each virtual memory page is advantageously a power of 2 such as, for example but not necessarily, 2¹² bytes=4096 bytes.

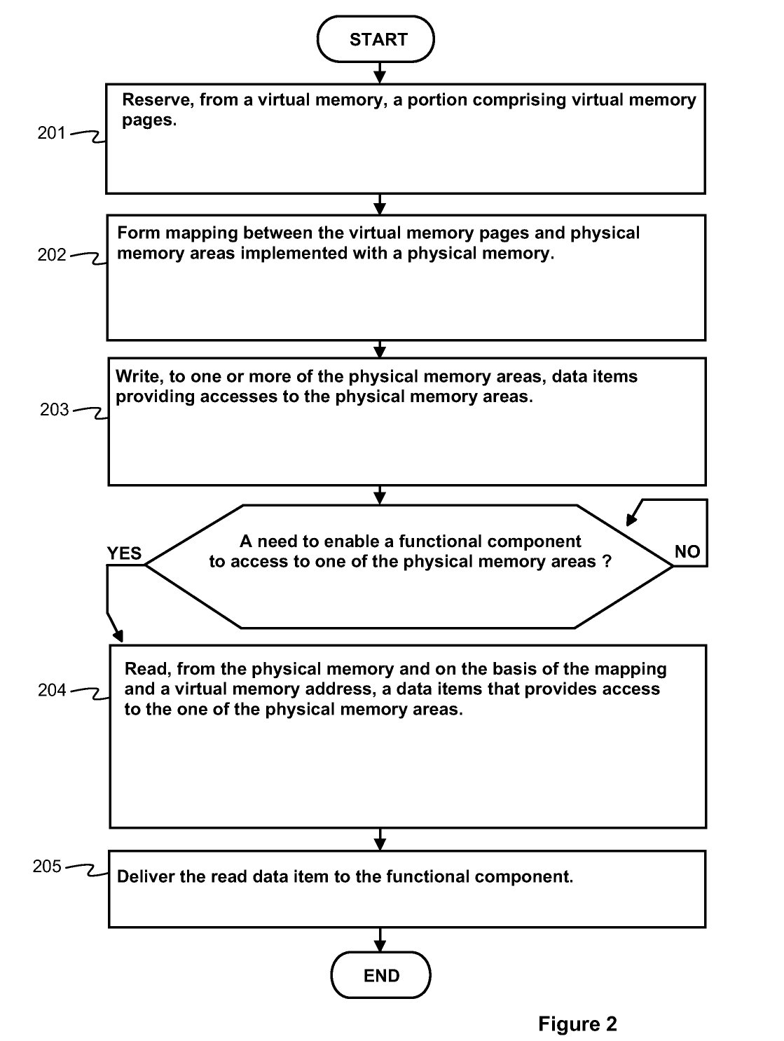

A method according to an exemplifying embodiment of the invention for controlling memory-usage of at least one functional component is illustrated below with reference to the data structure illustrated in FIG. 1 and to a method flow chart shown in FIG. 2. The above-mentioned functional component can be, for example but not necessarily, a network interface or a network processor “NP” of a network element of a data transfer network. Figure reference numbers having the first digit ‘1’ refer to FIG. 1, and correspondingly figure reference numbers having the first digit ‘2’ refer to FIG. 2. In a phase 201, the method comprises reserving a portion 110 of the virtual memory 111, where the portion comprises the virtual memory pages 112-116. As can be seen from FIG. 1, the reserved portion 110 does not necessarily have to start at a boundary between adjacent virtual pages and correspondingly the reserved portion 110 does not necessarily have to end at a boundary between adjacent virtual pages. In order to simplify the memory management, the reserved portion 110 of the virtual memory is advantageously a contiguous area of the virtual memory address space as illustrated in FIG. 1. In a phase 202, the method comprises forming the above-mentioned mapping between the virtual memory pages and the physical memory areas implemented with the physical memory 120. Changing the mapping is advantageously prevented for example in situations where another mapping between another virtual memory and other physical memory areas are formed or changed. The changes can be prevented for example with the aid of one or more suitable flag variables for indicating that the mapping under consideration is locked. In a phase 203, the method comprises writing, to each of the physical memory areas, a data item providing access to the physical memory area under consideration. Without limiting generality and for illustrative purposes, we consider the virtual memory pages 113 and 116 and the corresponding physical memory areas 119 and 117. In the exemplifying case illustrated in FIG. 1, the data item providing access to the physical memory area 117 is a data item 125a stored in the virtual memory page 116 and thereby in the physical memory area 117. The data item 125a may include the physical memory address related to the physical memory area 117 or information with the aid of which the physical memory address is derivable or obtainable. In this exemplifying case, the data item 125a is stored at the beginning of the virtual memory page 116 and thereby at the beginning of the physical memory area 117. The data item 125a may include information indicating for example the physical memory address of the beginning of the physical memory area 117. It is also possible that the data item 125a is stored at another pre-determined location of the virtual memory page 116 and thereby at the corresponding other location of the physical memory area 117. As well, it is also possible that the data item 125a includes information indicating the physical memory address of another pre-determined location of the physical memory area 117. Correspondingly, the data item providing access to the physical memory area 119 is a data item 125b stored in the virtual memory page 113 and thereby in the physical memory area 119.

In a case where there is a need to enable the functional component to access to one of the physical memory areas, the method comprises phases 204 and 205. In the phase 204, the method comprises reading, from the physical memory 120, the data item that provides access to the physical memory area under consideration. The data item is read on the basis of the mapping between the virtual and physical memories and a virtual memory address related to a virtual memory page mapped to the physical memory area under consideration. Without limiting generality and for illustrative purposes, we can assume that the physical memory area under consideration is the physical memory area 119. In this case, the virtual memory page under consideration is the virtual memory page 113 and the above-mentioned data item is the data item 125b. The data item 125b is advantageously read so that the virtual memory address related to the virtual memory page 113 is delivered to a memory management unit “MMU” connected to the physical memory 120 and configured to translate the virtual memory address to the corresponding physical memory address in accordance with the above-mentioned mapping. In the phase 205, the method comprises delivering information indicated by the read data item 125b to the functional component so as to enable the functional component to access to the physical memory area 119. The data item 125b can be delivered to the functional component, or derivative information can be obtained with the aid of the data item 125b and thereafter the derivative information can be delivered to the functional component. The derivative information can be for example a sum of an address value expressed by the data item 125b and a pre-determined offset.

In the exemplifying case illustrated in FIG. 1, each of the virtual memory pages is composed of two mutually non-overlapping, equal-sized, and contiguous virtual memory sub-pages. For example, the virtual memory page 116 is composed of the virtual memory sub-pages 121 and 122. Correspondingly, each of the physical memory areas comprises two mutually non-overlapping, equal-sized, and contiguous physical memory sub-areas so that each of the physical memory sub-areas correspond to one of the virtual memory sub-pages. For example, the physical memory area 117 comprises the physical memory sub-areas 123 and 124 which correspond to the virtual memory sub-pages 121 and 122, respectively. It is worth noting that the number of the virtual memory sub-pages in each virtual memory page and correspondingly the number of the physical memory sub-areas in each physical memory area can be also greater than two. As the physical memory sub-areas are mutually equal-sized, the physical memory address related to a physical memory sub-area can be computed on the basis of the physical memory address related to another physical memory sub-area in the same physical memory area. For example, the physical memory address of the memory location storing a data item 126a is the physical memory address of the memory location storing the data item 125a added with the size of the physical memory sub-areas 123 and 124. The size of the physical memory sub-areas, and of the virtual memory sub-pages, is advantageously a power of 2 such as, for example but not necessarily, 2¹¹ bytes=2048 bytes. The functional component using the physical memory areas can be made aware of the size of physical memory sub-areas so that the functional component is capable of forming, on the basis of the physical memory address related to one physical memory sub-area of a physical memory area, the corresponding physical memory addresses related to other physical memory sub-areas of the same physical memory area.

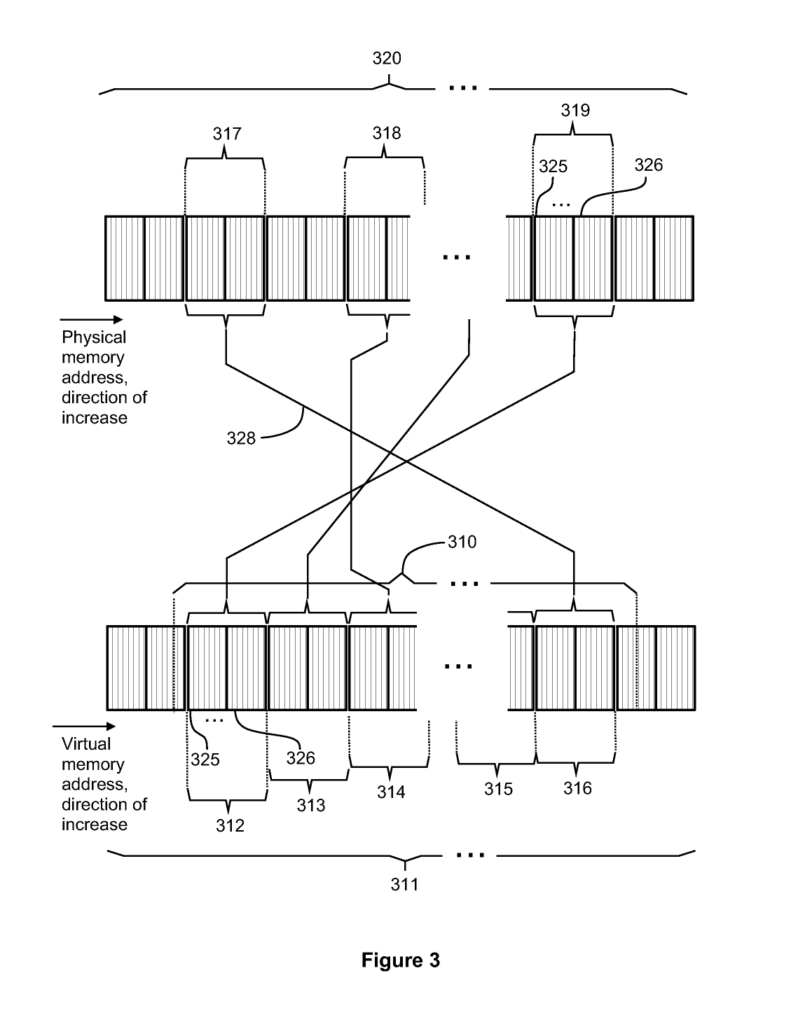

FIG. 3 illustrates an exemplifying data structure related to another exemplifying embodiment of the invention. A virtual memory 311 is organized to comprise fixed-length contiguous virtual memory pages. In FIG. 3, some of the virtual memory pages are denoted with reference numbers 312, 313, 314, 315, and 316. The virtual memory 311 is implemented with a physical memory 320 which can be realized with one or more memory devices such as for example one or more random access memory “RAM” circuits. The virtual memory pages are basic data units for managing the mapping between the virtual memory 311 and the physical memory 320. In FIG. 3, the mapping between the virtual memory pages and fixed-length contiguous physical memory areas of the physical memory 320 are illustrated with connection lines one of which is denoted with a reference number 328. In the exemplifying case illustrated in FIG. 3, the virtual memory page 312 is implemented with a physical memory area 319, the virtual memory page 314 is implemented with a physical memory area 318, and the virtual memory page 316 is implemented with a physical memory area 317.

A method according to an exemplifying embodiment of the invention for controlling memory-usage of at least one functional component is illustrated below with reference to the data structure illustrated in FIG. 3 and to a method flow chart shown in FIG. 2. Figure reference numbers having the first digit ‘3’ refer to FIG. 3, and correspondingly figure reference-numbers having the first digit ‘2’ refer to FIG. 2. In the phase 201, the method comprises reserving a portion 310 of the virtual memory 111, where the portion comprises, among others, the virtual memory pages 312-316. In order to simplify the memory management, the reserved portion 310 of the virtual memory is advantageously a contiguous area of the virtual memory address space as illustrated in FIG. 3. In the phase 202, the method comprises forming the above-mentioned mapping between the virtual memory pages and the physical memory areas implemented with the physical memory 320. In the phase 203, the method comprises writing to the physical memory area 319 mapped to the virtual memory page 312 data items providing accesses to the other ones of the physical memory areas under consideration. In FIG. 3, two of the data items are denoted with reference numbers 325 and 326. Without limiting generality and for illustrative purposes, we assume that the data item 325 provides access to the physical memory area 317 and that the data item 326 provides access to the physical memory area 318. The data item 325 can include a physical memory address related to the physical memory area 317 or information on the basis of which the physical memory address is derivable or obtainable. Correspondingly, the data item 326 can include a physical memory address related to the physical memory area 318 or information on the basis of which the physical memory address is derivable or obtainable.

In a case where there is a need to enable the functional component to access to e.g. the physical memory area 318, the method comprises the phases 204 and 205. In the phase 204, the method comprises reading, from the physical memory 320, the data item 326 that provides access to the physical memory area 318. The reading operation may comprise obtaining a virtual memory address of the data item 326 on the basis of the virtual memory address related to the virtual memory page 314 that is mapped to the physical memory area 318 under consideration. Thereafter, the virtual memory address of the data item 326 is delivered to a memory management unit “MMU” connected to the physical memory 320 and configured to translate the virtual memory address of the data item 326 to the corresponding physical memory address of the data item 326 in accordance with the above-mentioned mapping between the virtual memory pages and the physical memory areas. In a method according to an exemplifying embodiment of the invention, a look-up table of virtual memory addresses related to the virtual memory page 312 and providing accesses to the data items 325, . . . 326 is maintained. In order to obtain the virtual memory address of the data item 326, a look-up is carried out using the virtual memory address related to the virtual memory page 314 as a look-up key. In a method according to another exemplifying embodiment of the invention, the virtual memory address of the data item 326 is obtained with one or more logical and/or mathematical operations directed to the virtual memory address related to the virtual memory page 314.

A computer program according to an exemplifying embodiment of the invention comprises computer executable instructions for controlling a programmable processor to carry out a method according to any of the above-described exemplifying embodiments of the invention.

A computer program according to an exemplifying embodiment of the invention comprises software modules for controlling memory-usage of at least one functional component. The software modules comprise computer executable instructions for controlling a programmable processor to:
reserve a portion of a virtual memory, the reserved portion of the virtual memory comprising one or more mutually non-overlapping and contiguous virtual memory pages,
form mapping between the virtual memory pages and physical memory areas implemented with a physical memory, a particular one of the physical memory areas being mapped to a particular one of the virtual memory pages, and
write, to one or more of the physical memory areas mapped to the virtual memory pages, data items providing accesses to the physical memory areas.

The computer program further comprises computer executable instructions for controlling a programmable processor to carry out the following actions in order to enable the functional component to access to the one of the physical memory areas:
reading, from the physical memory and on the basis of at least the mapping and a virtual memory address related to the one of the virtual memory pages, a particular one of the data items that provides access to the one of the physical memory areas, and
delivering information indicated by the read data item to the functional component so as to enable the functional component to access to the one of the physical memory areas.

The software modules can be e.g. subroutines or functions implemented with a suitable programming language and with a compiler suitable for the programming language and the programmable processor.

A computer program product according to an embodiment of the invention comprises a computer readable medium, e.g. a compact disc (“CD”), encoded with a computer program according to an embodiment of invention.

A signal according to an embodiment of the invention is encoded to carry information defining a computer program according to an embodiment of invention.

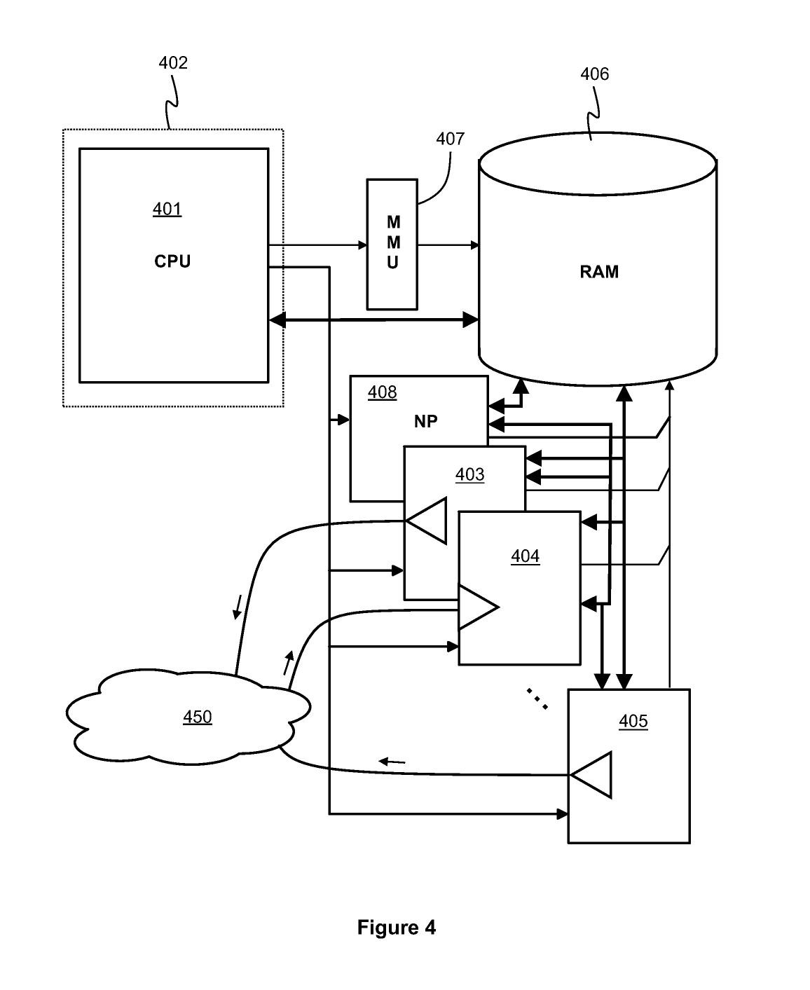

FIG. 4 shows a schematic illustration of a network element according to an exemplifying embodiment of the invention. The network element can be for example an Internet Protocol “IP” router, an Ethernet switch, a multiprotocol label switching “MPLS” switch, a network element of a software defined network “SDN”, and/or an Asynchronous Transfer Mode “ATM” switch. The network element comprises network interfaces for transmitting data to a data transfer network 450 and network interfaces for receiving data from the data transfer network. In FIG. 4, two of the network interfaces for transmitting data are denoted with reference numbers 403 and 405, and one of the network interfaces for receiving data is denoted with a reference number 404. The network element comprises a network processor “NP” 408 for running data transfer protocols being used, e.g. IP, the Transmission Control Protocol “TCP”, Ethernet, ATM, and/or MPLS. The network interfaces and the network processor represent functional components for controlling and carrying out data transfer between the network element and the data transfer network 450. The network element comprises a physical memory 406 for buffering the data received and to be transmitted. The physical memory 406 can be realized with one or more memory devices such as for example one or more random access memory “RAM” circuits. The network element comprises a processor system 401 connected to the physical memory 406 and to the network interfaces 403-405. The processor system 401 is configured to constitute a device 402 for controlling usage of the physical memory 406 by the network interfaces 403-405. The processor system 401 can be implemented with one or more processor circuits, each of which can be a programmable processor circuit provided with appropriate software, a dedicated hardware processor such as, for example, an application specific integrated circuit “ASIC”, or a configurable hardware processor such as, for example, a field programmable gate array “FPGA”. In the exemplifying case illustrated in FIG. 4, the processor system 401 is a central processor unit “CPU” of the network element and the device 402 is implemented with suitable programmatic means executable by the CPU and/or hardware means belonging to the CPU. It is, however, also possible that the device for controlling the usage of the physical memory 406 comprises hardware means separate from the CPU. In conjunction with some hardware architectures, the network processor “NP” 408 is implemented with the same hardware as the CPU, whereas in conjunction with some other hardware architectures, the network processor “NP” 408 is implemented with the separate hardware.

The functionality of the network element in an exemplifying situation is illustrated below with reference to FIGS. 4, 1 and 3. Figure reference numbers having the first digit ‘1’ refer to FIG. 1, figure reference numbers having the first digit ‘3’ refer to FIG. 3, and figure reference numbers having the first digit ‘4’ refer to FIG. 4. The processor system 401 is configured to:
reserve the portion 110, 310 of the virtual memory 111, 311, where the reserved portion comprises the one or more mutually non-overlapping and contiguous virtual memory pages 112-116, 312-316,
form the mapping between the virtual memory pages and the physical memory areas implemented with the physical memory 406, the first one of the physical memory areas 117, 318 being mapped to the first one of the virtual memory pages 116, 314, and
write, to one or more of the physical memory areas mapped to the virtual memory pages 112-116, 312, the data items 125a, 125b, 325, 326 providing accesses to the physical memory areas.

In order to enable one of the network interfaces 403-405 or the network processor 408 to access to the first one of the physical memory areas 117, 318, the processor system 401 is further configured to:
read, from the physical memory 406 and on the basis of at least the mapping and the virtual memory address related to the first one of the virtual memory pages 116, 314, a particular one of the data items 125a, 326 that provides access to the first one of the physical memory areas 117, 318, and
deliver information indicated by the read data item 125a, 326 to the one of the network interfaces or to the network processor 408 so as to enable the network interface or the network processor to access to the first one of the physical memory areas 117, 318.

In a network element according to an exemplifying embodiment of the invention:
each of the virtual memory pages is composed of two or more mutually non-overlapping, equal-sized, and contiguous virtual memory sub-pages 121, 122, and
each of the physical memory areas comprises two or more mutually non-overlapping, equal-sized, and contiguous physical memory sub-areas 123, 124 each corresponding to one of the virtual memory sub-pages of the corresponding virtual memory page.

The network interfaces 403-405 and/or the network processor 408 can be configured to use linked lists of the physical memory sub-areas for buffering the data received and to be transmitted. The data can be handled, for example, as protocol data units “PDU” such as Internet Protocol “IP” packets or Ethernet frames. Each protocol data unit can be stored to one or more of the physical memory sub-areas so that, when two or more physical memory sub-areas are needed, the two or more physical memory sub-areas constitute a linked list. The size of each physical memory sub-area, and of each virtual memory sub-page, can be for example 2048 bytes.

In a network element according to another exemplifying embodiment of the invention, each of the network interfaces 403-405 and/or the network processor 408 is configured to use linked lists of the physical memory areas for buffering the data received and to be transmitted. The size of each physical memory area, and of each virtual memory page, can be for example 4096 bytes.

In a network element according to an exemplifying embodiment of the invention, the processor system 401 is configured to reserve the portion 110, 310 of the virtual memory so that the reserved portion of the virtual memory is contiguous in the address space of the virtual memory 111, 311.

In a network element according to an exemplifying embodiment of the invention, the processor system 401 is configured to write the data items 125a, 125b, 325, 326 so that each of the data items includes a physical memory address related to the physical memory area accessible with the aid of the data item under consideration.

In a network element according to an exemplifying embodiment of the invention, the processor system 401 is configured to write each of the data items 125a, 125b to a particular one of the physical memory areas 117, 119 that is accessible with the aid of the data item under consideration. In this case, the processor system 401 is advantageously configured to read the one of the data items 125a so that the virtual memory address related to the first one of the virtual memory pages 116 is delivered to a memory management unit “MMU” 401 connected to the physical memory 406 and configured to translate the virtual memory address to a physical memory address in accordance with the mapping between the virtual and physical memories.

In a network element according to an exemplifying embodiment of the invention, the processor system 401 is configured to write all the data items 325, 326 providing accesses to the physical memory areas to a second one of the physical memory areas 319 mapped to a second one of the virtual memory pages 312. In this case, the processor system 401 is configured to carry out the following actions in order to read the one of the data items 326:
obtaining, on the basis of the virtual memory address related to the first one of the virtual memory pages 314, another virtual memory address related to the second one of the virtual memory pages 312 and providing access to the one of the data items 326, and
delivering the other virtual memory address to the memory management unit “MMU” 407 connected to the physical memory 406 and configured to translate the other virtual memory address to a physical memory address in accordance with the mapping.

In a network element according to an exemplifying embodiment of the invention, the processor system 401 is configured to maintain a look-up table of virtual memory addresses related to the second one of the virtual memory pages 312 and providing accesses to the data items 325, 326. The processor system 401 is configured, in order to obtain the other virtual memory address providing the access to the one of the data items 326, to carry out a look-up using the virtual memory address related to the first one of the virtual memory pages 314 as a look-up key.

In a network element according to an exemplifying embodiment of the invention, the processor system 401 is configured to carry out one or more logical operations for obtaining, on the basis of the virtual memory address related to the first one of the virtual memory pages 314, the other virtual memory address related to the second one of the virtual memory pages 312 and providing access to the one of the data items 326.

In a network element according to an exemplifying embodiment of the invention, the processor system 401 is configured to prevent changes of the mapping between the above-mentioned virtual memory pages and the above-mentioned physical memory areas in situations where another mapping between another virtual memory and other physical memory areas of the physical memory 406 is formed or changed.

The specific examples provided in the description given above should not be construed as limiting the scope and/or the applicability of the appended claims.

What is claimed is:

1. A device for controlling memory-usage of at least one functional component, the device comprising a processor system configured to:
reserve a portion of a virtual memory, the reserved portion of the virtual memory comprising one or more mutually non-overlapping and contiguous virtual memory pages,
form mapping between the virtual memory pages and physical memory areas implemented with a physical memory, a first one of the physical memory areas being mapped to a first one of the virtual memory pages, and
write, to one or more of the physical memory areas mapped to the virtual memory pages, data items providing accesses to the physical memory areas,
wherein, in order to enable the functional component to access to the first one of the physical memory areas, the processor system is further configured to:
read, from the physical memory and on the basis of at least the mapping and a virtual memory address related to the first one of the virtual memory pages, a particular one of the data items that provides access to the first one of the physical memory areas, and
deliver information indicated by the read data item to the functional component so as to enable the functional component to access to the first one of the physical memory areas.

2. A device according to claim 1, wherein the processor system is configured to reserve the portion of the virtual memory so that the reserved portion of the virtual memory is contiguous.

3. A device according to claim 1, wherein the processor system is configured to write the data items so that each of the data items includes a physical memory address related to the physical memory area accessible with the aid of the data item under consideration.

4. A device according to claim 1, wherein the processor system is configured to write each of the data items to a particular one of the physical memory areas that is accessible with the aid of the data item under consideration.

5. A device according to claim 4, wherein the processor system is configured, in order to read the one of the data items, to deliver the virtual memory address related to the first one of the virtual memory pages to a memory management unit connected to the physical memory and configured to translate the virtual memory address to a physical memory address in accordance with the mapping.

6. A device according to claim 1, wherein the processor system is configured to write the data items to a second one of the physical memory areas mapped to a second one of the virtual memory pages.

7. A device according to claim 6, wherein the processor system is configured, in order to read the one of the data items, to:
obtain, on the basis of the virtual memory address related to the first one of the virtual memory pages, another virtual memory address related to the second one of the virtual memory pages and providing access to the one of the data items, and
deliver the other virtual memory address to a memory management unit connected to the physical memory and configured to translate the other virtual memory address to a physical memory address in accordance with the mapping.

8. A device according to claim 7, wherein the processor system is configured to maintain a look-up table of virtual memory addresses related to the second one of the virtual memory pages and providing accesses to the data items, and, in order to obtain the other virtual memory address related to the second one of the virtual memory pages and providing access to the one of the data items, to carry out a look-up using the virtual memory address related to the first one of the virtual memory pages as a look-up key.

9. A device according to claim 7, wherein the processor system is configured to carry out one or more logical operations for obtaining, on the basis of the virtual memory address related to the first one of the virtual memory pages, the other virtual memory address related to the second one of the virtual memory pages and providing access to the one of the data items.

10. A device according to claim 1, wherein the processor system is configured to prevent changes of the mapping between the virtual memory pages and the physical memory areas in situations where another mapping between another virtual memory and other physical memory areas is formed or changed.

11. A network element comprising:
one or more functional components for controlling and carrying out data transfer between the network element and a data transfer network,
a physical memory for buffering data to be transferred, and
a processor system connected to the physical memory and to the one or more functional components,
wherein the processor system is configured to:
reserve a portion of a virtual memory, the reserved portion of the virtual memory comprising one or more mutually non-overlapping and contiguous virtual memory pages,
form mapping between the virtual memory pages and physical memory areas implemented with the physical memory, a first one of the physical memory areas being mapped to a first one of the virtual memory pages, and
write, to one or more of the physical memory areas mapped to the virtual memory pages, data items providing accesses to the physical memory areas,
wherein, in order to enable at least one of the functional components to access to the first one of the physical memory areas, the processor system is further configured to:
read, from the physical memory and on the basis of at least the mapping and a virtual memory address related to the first one of the virtual memory pages, a particular one of the data items that provides access to the first one of the physical memory areas, and
deliver information indicated by the read data item to the functional component under consideration so as to enable the functional component to access to the first one of the physical memory areas.

12. A network element according to claim 11, wherein each of the functional components is configured to use linked lists of the physical memory areas for buffering the data received and to be transmitted.

13. A network element according to claim 11, wherein:
each of the virtual memory pages is composed of two or more mutually non-overlapping, equal-sized, and contiguous virtual memory sub-pages, and
the physical memory area mapped to the virtual memory page under consideration comprises two or more mutually non-overlapping, equal-sized, and contiguous physical memory sub-areas each corresponding to one of the virtual memory sub-pages.

14. A network element according to claim 13, wherein each of the functional components is configured to use linked lists of the physical memory sub-areas for buffering the data received and to be transmitted.

15. A network element according to claim 11, wherein the network element is at least one of the following: an Internet Protocol “IP” router, an Ethernet switch, a multiprotocol label switching “MPLS” switch, a network element of a software defined network “SDN”, an Asynchronous Transfer Mode “ATM” switch.

16. A method for controlling memory-usage of at least one functional component the method comprising:
reserving a portion of a virtual memory, the reserved portion of the virtual memory comprising one or more mutually non-overlapping and contiguous virtual memory pages,
forming mapping between the virtual memory pages and physical memory areas implemented with a physical memory, a first one of the physical memory areas being mapped to a first one of the virtual memory pages, and
writing, to one or more of the physical memory areas mapped to the virtual memory pages, data items providing accesses to the physical memory areas, wherein, in order to enable the functional component to access to the first one of the physical memory areas, the method further comprises:
reading, from the physical memory and on the basis of at least the mapping and a virtual memory address related to the first one of the virtual memory pages, a particular one of the data items that provides access to the first one of the physical memory areas, and
delivering information indicated by the read data item to the functional component so as to enable the functional component to access to the first one of the physical memory areas.

17. A method according to claim 16, wherein the portion of the virtual memory is contiguous.

18. A method according to claim 16, wherein each of the data items includes a physical memory address related to the physical memory area accessible with the aid of the data item under consideration.

19. A method according to claim 16, wherein each of the data items is written to a particular one of the physical memory areas that is accessible with the aid of the data item under consideration.

20. A method according to claim 19, wherein the method comprises, in order to read the one of the data items, delivering the virtual memory address related to the first one of the virtual memory pages to a memory management unit connected to the physical memory and configured to translate the virtual memory address to a physical memory address in accordance with the mapping.

21. A method according to claim 16, wherein the data items are written to a second one of the physical memory areas mapped to a second one of the virtual memory pages.

22. A method according to claim 21, wherein the method comprises, in order to read the one of the data items:
obtaining, on the basis of the virtual memory address related to the first one of the virtual memory pages, another virtual memory address that is related to the second one of the virtual memory pages and provides access to the one of the data items, and
delivering the other virtual memory address to a memory management unit connected to the physical memory and configured to translate the other virtual memory address to a physical memory address in accordance with the mapping.

23. A method according to claim 22, wherein the method comprises maintaining a look-up table of virtual memory addresses related to the second one of the virtual memory pages and providing accesses to the data items, and, in order to obtain the other virtual memory address related to the second one of the virtual memory pages and providing access to the one of the data items, carrying out a look-up using the virtual memory address related to the first one of the virtual memory pages as a look-up key.

24. A method according to claim 22, wherein the method comprises carrying out one or more logical operations for obtaining, on the basis of the virtual memory address related to the first one of the virtual memory pages, the other virtual memory address related to the second one of the virtual memory pages and providing access to the one of the data items.

25. A method according to claim 16, wherein the method comprises preventing changes of the mapping between the virtual memory pages and the physical memory areas in situations where another mapping between another virtual memory and other physical memory areas is formed or changed.

26. A method according to claim 16, wherein:
each of the virtual memory pages is composed of two or more mutually non-overlapping, equal-sized, and contiguous virtual memory sub-pages, and
the physical memory area mapped to the virtual memory page under consideration comprises two or more mutually non-overlapping, equal-sized, and contiguous physical memory sub-areas each corresponding to one of the virtual memory sub-pages.

27. A non-transitory computer readable medium encoded with a computer program for controlling memory-usage of at least one functional component, the computer program comprising computer executable instructions for controlling a programmable processor to:
reserve a portion of a virtual memory, the reserved portion of the virtual memory comprising one or more mutually non-overlapping and contiguous virtual memory pages,
form mapping between the virtual memory pages and physical memory areas implemented with a physical memory, a first one of the physical memory areas being mapped to a first one of the virtual memory pages, and
write, to one or more of the physical memory areas mapped to the virtual memory pages, data items providing accesses to the physical memory areas,
wherein the computer program further comprises computer executable instructions for controlling the programmable processor to carry out the following actions in order to enable the functional component to access to the first one of the physical memory areas:
reading, from the physical memory and on the basis of at least the mapping and a virtual memory address related to the first one of the virtual memory pages, a particular one of the data items that provides access to the first one of the physical memory areas, and
delivering information indicated by the read data item to the functional component so as to enable the functional component to access to the first one of the physical memory areas.
